(19) United States
(12) Patent Application Publication
(10) Pub. No.: US 2012/0125855 A1
(43) Pub. Date: May 24, 2012

(54) METHOD FOR TREATING LIQUID CONTAINING PERCHLORATE ION

(75) Inventors: Yoshinobu Hachiki, Osaka (JP); Masanari Aihara, Osaka (JP); Osamu Suzuki, Tokyo (JP); Satoshi Miki, Tokyo (JP); Kazuhide Nishida, Tokyo (JP)

(73) Assignee: Sumika Chemtex Company, Limited, Osaka (JP)

(21) Appl. No.: 13/295,698

(22) Filed: Nov. 14, 2011

(30) Foreign Application Priority Data
Nov. 15, 2010 (JP) 2010-254904

(51) Int. Cl. B01D 15/36; B01J 49/00

(52) U.S. Cl. 210/670; 521/26

(57) ABSTRACT

The present invention provides a novel and practical method for treating a perchlorate ion-containing liquid. The perchlorate ion-containing liquid is brought into contact with a weak base anion exchange resin, so that perchlorate ions are adsorbed to the weak base anion exchange resin, and then an acid is brought into contact with the resin, so as to remove the perchlorate ions from the weak base anion exchange resin to which the perchlorate ions are adsorbed. This makes it possible to repeatedly use the weak base anion exchange resin.

This Nonprovisional application claims priority under 35U.S.C. §119(a) on Patent Application No. 2010/254904 filed in Japan on Nov. 15, 2010, the entire contents of which are hereby incorporated by reference.

### TECHNICAL FIELD

The present invention relates to a method for treating a liquid containing perchlorate ions (perchlorate ion-containing liquid).

### BACKGROUND ART

Perchlorate ions (ClO₄−) are highly soluble in water, and stable to be difficult to break down.

Known Examples of methods for treating perchlorate ions encompass a method in which FeCl₄ is used (see Patent Literature 1, for example), and a method in which perchlorate ions are adsorbed to a strong base anion exchange resin having a quaternary alkyl amine group (see Patent Literature 2, for example).

### CITATION LIST

### Patent Literatures

Patent Literature 1
U.S. Pat. No. 6,448,299 B1 (Sep. 10, 2002)
Patent Literature 2
Japanese Patent Application Publication, Tokukai, No. 2004-346299 A (published on Dec. 9, 2004)

### SUMMARY OF INVENTION

### Technical Problem

However, the conventional methods of treating perchlorate ions are unpractical due to the following drawbacks.

Specifically, the method recited in Patent Literature 1 requires that FeCl₄ be removed after the treatment. The method in Patent Literature 2 for removing the perchlorate salt is based on such a premise that the resin is removed from a water treatment system after the resin adsorbed the perchlorate salt, and then transported to an incinerator or discarded in a site for a reclaiming land etc.

The present invention was accomplished in view of such drawbacks, and an object of the present invention is to provide a novel practical method for treating perchlorate ion-containing liquid.

### Solution to Problem

In order to attain the object, a method according to the present invention for treating a perchlorate ion-containing liquid, includes: an adsorption step for bringing the perchlorate ion-containing liquid into contact with a weak base anion exchange resin, so that perchlorate ions are adsorbed to the weak base anion exchange resin; and a removing step for bringing an acid into contact with the weak base anion exchange resin to which the perchlorate ions are adsorbed, so as to remove the perchlorate ions from the weak base anion exchange resin, thereby regaining the adsorption ability of the weak base anion exchange resin.

With this arrangement, it is possible to regain the adsorption ability of the weak base anion exchange resin by removing the perchlorate ions from the weak base anion exchange resin to which the perchlorate ions are adsorbed. Therefore, the weak base anion exchange resin can be repeatedly used.

### Advantageous Effects of Invention

As described above, the method according to the present invention for treating a perchlorate ion-containing liquid can provide an efficient and novel method, which includes: an adsorption step for bringing the perchlorate ion-containing liquid into contact with a weak base anion exchange resin, so that perchlorate ions are adsorbed to the weak base anion exchange resin; and a removing step for bringing an acid into contact with the weak base anion exchange resin to which the perchlorate ions are adsorbed, so as to remove the perchlorate ions from the weak base anion exchange resin, thereby regaining the adsorption ability of the weak base anion exchange resin.

### BRIEF DESCRIPTION OF DRAWINGS

FIG. 1 is a schematic configuration view illustrating one example of a treating device usable in the present invention for treating a perchlorate ion-containing liquid.

FIG. 2 is a view illustrating results of testing liquid flowing methods in a removing step, prior to liquid flow adsorption/removal tests for a perchlorate ion-containing liquid in Examples of the present invention.

### DESCRIPTION OF EMBODIMENTS

The inventors of the present invention diligently studied on solutions for the drawbacks of the disposal use of the ion exchange resin in the conventional method of treating perchlorate ions by using the ion exchange resin. As a result, the inventors of the present invention found that the perchlorate ions can be appropriately removed by bringing an acid into contact with the perchlorate ions adsorbed on the resin after the adsorption of the perchlorate ions to the resin that is a weak base anion exchange resin. Based on the finding, the present invention was accomplished.

In the following, one embodiment of the present invention is described in the order of (I) method for treating a perchlorate ion-containing liquid, and (II) device for treating perchlorate ion-containing liquid.

(I) Method for Treating a Perchlorate Ion-Containing Liquid

Perchlorate ion-containing liquids are targets to be treated by the method of the present invention, and is not particularly limited, provided that the perchlorate ion-containing liquids are liquid containing perchlorate ions. The perchlorate solutions may be, for example, ground water, soil, hot spring water, pond or lake water, sea water, industrial waste water, mine waste water, river water, etc. Especially, the present invention is effective to treat industrial waste water containing perchlorate ions in high concentration from factories for producing solid fuel for rockets, fireworks, smoke candles for automobiles, etc.

Moreover, the method of the present invention for treating a perchlorate ion-containing liquid can appropriately remove perchlorate ions from targets of wide concentration ranges, from highly concentrated perchlorate ion-containing liquids to lowly concentrated perchlorate ion-containing liquids. The perchlorate ion-containing liquid to be treated is not particularly limited as to its perchlorate ion concentration, but preferably has a perchlorate ion concentration not less than 10 μg/L but not more than 1000 mg/L.

In the treatment of the perchlorate ion-containing liquid is to reduce or remove the perchlorate ions in the perchlorate ion-containing liquid.

A method according to the present invention for treating a perchlorate ion-containing liquid comprises: an adsorption step for bringing the perchlorate ion-containing liquid into contact with a weak base anion exchange resin, so that perchlorate ions are adsorbed to the weak base anion exchange resin; and a removing step for bringing an acid into contact with the weak base anion exchange resin to which the perchlorate ions are adsorbed, so as to remove the perchlorate ions from the weak base anion exchange resin, thereby regaining the adsorption ability of the weak base anion exchange resin.

(I-1) Adsorption Step

The adsorption step in the present invention is a step of bringing the perchlorate ion-containing liquid into contact with the weak base anion exchange resin, so that the perchlorate ions are adsorbed to the weak base anion exchange resin.

In the present invention, the weak base anion exchange resin is a base anion exchange resin in which a ratio of a neutral salt splitting capacity to a total exchange capacity, that is, a value=(neutral salt splitting capacity/total exchange capacity)×100, is not less than 0 but not more than 40%. The quaternary ammonium group accounts for the neutral salt splitting capacity. So, an increase in the Quaternary ammonium group results in an increase in the neutral salt splitting capacity. Here, the neutral salt splitting capacity and the total exchange capacity are determined by a method explained in “(ii) Measurement of the neutral salt splitting capacity and the total exchange capacity of weak base anion exchange resin” later described. That is, in the present invention, the weak base anion exchange resin encompasses resins commercially available as a strong base anion exchange resin, provided that the ratio of the neutral salt splitting capacity to the total exchanging capacity of the resins is not less than 0 but not more than 40%.

By being an ion exchange resin having the ratio of the neutral salt splitting capacity to the total exchanging capacity not less than 0 but not more than 40%, the weak base anion exchange resin used in the present invention is capable of releasing the perchlorate ions adsorbed on the weak base anion exchange resin, thereby regaining its adsorption ability. Hence, the weak base anion exchange resin used in the present invention can be repeatedly used. The ratio of the neutral salt splitting capacity to the total exchanging capacity of the weak base anion exchange resin is more preferably not less than 1% but not more than 20%, and further preferably not less than 3% but not more than 15%.

The weak base anion exchange resin has, as a main exchange group, at least one selected from the group consisting of tertiary amino groups, secondary amino groups, and primary amino groups. Moreover, it is preferable that the weak base anion exchange resin further has a quaternary ammonium group, provided that the ratio of the neutral salt splitting capacity to the total exchanging capacity of the weak base anion exchange resin is not less than 0 but not more than 40%.

The tertiary amino group is not particularly limited, provided that it has a structure represented by —NR¹R², where R¹ and R² are independently an organic group that is not limited to a particular one. The tertiary amino group is more preferably a dialkyl amino group among the amino groups having the structure. The dialkyl amino group is not particularly limited, provided that it has the structure represented by —NR¹R², where R¹ and R² are independently an alkyl group. However, it is preferable that R¹ and R² are independently a C₁ to C₅ alkyl group. Some specific examples of the dialkyl amino group encompass dimethyl amino group, diethyl amino group, dipropyl amino group, etc.

The secondary amino group is not particularly limited, provided that it has a structure represented by —NHR³, where R³ is an organic group. The secondary amino group is more preferably a monoalkyl amino group among the amino groups having the structure. The monoalkyl amino group is not particularly limited, provided that it has the structure represented by —NHR³, where R³ is an alkyl group. However, it is preferable that R³ is a C₁ to C₅ alkyl group. Some specific examples of the alkyl amino group encompass methyl amino group, ethyl amino group, propyl amino group, etc. As an alternative, R³ may be a polyamine.

The quaternary ammonium group is not particularly limited, provided that it has a structure represented by —NR¹R²R³, where R¹, R², and R³ are independently an organic group. The quaternary ammonium group is more preferably a trialkyl ammonium group among the ammonium groups having the structure. The trialkyl ammonium group is not particularly limited, provided that it has the structure represented by —NR¹R²R³, where R¹, R², and R³ are independently an alkyl group. However, it is preferable that R¹, R², and R³ are independently a C₁ to C₅ alkyl group. Some specific examples of the trialkyl ammonium group encompass trimethyl ammonium group, triethyl ammonium group, tripropyl ammonium group, etc.

As described above, the weak base anion exchange resin has, an exchange group, at least one selected from the group consisting of tertiary amino groups, secondary amino groups, and primary amino groups, and may further has a quaternary ammonium group as an exchange group. These exchange groups are bonded to a polymer backbone of the resin via a divalent organic group. The divalent organic group is not particularly limited, but for example, may be an alkylene group such as methylene group, ethylene group, etc.

The inventors of the present invention found such a surprising fact that reduction in the adsorption ability of the resin is hardly observed even after repeatedly subjecting the weak base anion exchange resin to the adsorption step and removing step, when the weak base anion exchange resin is one having, as an exchange group, at least one selected from group consisting of dialkyl groups, monoalkyl groups, and amino groups.

That is, in case where the weak base anion exchange resin has, as an exchange group, at least one selected from group consisting of dialkyl groups, monoalkyl groups, and amino groups, it is not only possible to appropriately remove the perchlorate ions adsorbed on the resin, but it is also possible to sustain the adsorption ability of the resin for adsorbing the perchlorate ions even after repeatedly subjecting the resin for the adsorption and removal of the perchlorate ions. Hence, repeated use of the resin is possible.

Moreover, the weak base anion exchange resin with such a configuration would possibly show initial reduction in the adsorption ability of the resin after repeatedly subjecting the resin to the adsorption step and the removing step. However, even if so, the reduction in the adsorption ability of the resin is stopped and the adsorption ability of the resin is sustained at a certain level after repeatedly subjecting the resin to the adsorption step and the removing step certain times.

That is, the use of the weak base anion exchange resin in treating the perchlorate ion-containing liquid makes it possible not only to appropriately remove the perchlorate ions from the weak base anion exchange resin where the perchlorate ions are adsorbed, but also to sustain the adsorption ability for adsorbing the perchlorate ions even after repeatedly subjecting the resin for the adsorption and removal of the perchlorate ions. Thus, it is possible to repeatedly use the weak base anion exchange resin.

The polymer backbone of the weak base anion exchange is not particularly limited. Examples of the polymer backbone encompass styrene resin, acrylic resin, phenol resin, etc. The styrene resin is not particularly limited. Examples of the styrene resin encompass copolymer of styrene and divinyl benzene, and the like polymers. Moreover, the acrylic resin is not particularly limited. Examples of the acrylic resin encompass copolymers of (i) acrylic acid, methacrylic acid, and/or esters thereof, and (ii) divinyl benzene, and the like polymers. Moreover, the phenol resin is not particularly limited. Examples of the phenol resin encompass phenol formalin copolymer, etc. Among these, it is preferable that the polymer backbone of the weak base anion exchange reins is styrene resin in view of the adsorption ability for adsorbing the perchlorate ions.

More specific examples of the weak base anion exchange resin encompass duolite (registered trademark) A368S, A378D, A375LF, A561, A568, PWA7, and A134LF of Rohm and Haas company; Amberlite (registered trademark) IRA68, IRA93, A21, IRA478RFC1, IRA67, IRA96SB, XT6050RF, XE583 of Rohm and Haas company; Diaion (registered trademark) WA10, WA11, WA20, WA21, and WA30 of Mitsubishi Chemical Corp.; Lewatit (registered trademark) MP62, PM64, AP49, CA9222 of Lanxess; Purolite (registered trademark) A105, A100, A103S, A123S, A830, A830W, A845, A847, and A870 of Purolite international K.K.; Dowex (registered trademark) 66, MWA-1, D-3, Marathon WBA, monosphere 77 of the dow chemical company; sumichelate (registered trademark) MC 300 of Sumika chemtex Co., Ltd.; and the like.

The weak base anion exchange resin is not particularly limited in terms of shape, provided that the weak base anion exchange resin has a particle-like shape. For example, the weak base anion exchange resin may have a spherical shape, a fracture shape, or the like. Moreover, the weak base anion exchange resin is not particularly limited in terms of its average particle diameter. For example, the weak base anion exchange resin having an average particle diameter of not less than 0.1 mm but not more than 2 mm can be suitably used.

The weak base anion exchange resin may be a commercially available weak base anion exchange resin exemplified above, or may be produced from a conventionally known production method for producing a weak base anion exchange resin. For example, the weak base anion exchange resin whose polymer backbone is styrene resin may be produced by introducing a haloalkyl group (such as chloromethyl group, for example) to the polymer backbone, and then reacting the haloalkyl group with at least one of a primary amine and a secondary amine by a conventionally known method. The weak base anion exchange resin thus obtained by the production method may have a quaternary ammonium group partially. Thus, it is possible to produce a weak base anion exchange resin in which the ratio of the neutral salt splitting capacity to the total exchange capacity is not less than 0 but not more than 40%.

Moreover, the production method may be such that a haloalkyl group is introduced in the polymer backbone, and then the haloalkyl group is reacted with at least one of a primary amine and a secondary amine, and additionally with a tertiary amine, such that the ratio of the neutral salt splitting capacity to the total exchange capacity is not less than 0 but not more than 40%.

The adsorption step is not particularly limited, provided that it brings the perchlorate ion-containing liquid into contact with the weak base anion exchange resin, so that the perchlorate is adsorbed on the weak base anion exchange resin. For example, the weak base anion exchange resin may be immersed in the perchlorate ion-containing liquid, thereby adsorbing the perchlorate ions to the weak base anion exchange resin. The weak base anion exchange resin may be added into the perchlorate ion-containing liquid, followed by stirring or shaking, so as to adsorb the perchlorate ions to the weak base anion exchange resin. As an alternative, the perchlorate ion-containing liquid may be brought into contact with the weak base anion exchange resin by a column method. That is, the perchlorate ion-containing liquid may be flowed through an adsorption column in which the weak base anion exchange resin is charged, thereby adsorbing the perchlorate ions to the weak base anion exchange resin.

Among them, it is preferable to employ the column method for bringing the perchlorate ion-containing liquid into contact with the weak base anion exchange resin, because column method can perform easy and efficient adsorption of the perchlorate ions.

Moreover, it is more preferable that the perchlorate ion-containing liquid to be brought into contact with the weak base anion exchange resin has a pH of 2 to 12. The pH of the perchlorate ion-containing liquid in the above range can facilitate the adsorption of the perchlorate ions to the weak base anion exchange resin. If a pH adjusting step for adjusting the pH of the perchlorate ion-containing liquid into the above range, the pH adjusting step is carried out before the adsorption step. How to adjust the ph of the perchlorate ion-containing liquid into the above range is not particularly limited, and may be carried out by a conventionally known method.

The adsorption step carried out by the column method is not particularly limited in terms of a flow rate of the flow of the perchlorate ion-containing liquid through the adsorption column. The flow rate may be optimized as appropriate, but may be such that SV=5 to 20, more preferably. SV is a unit indicating a volumetric ratio of the solution flowing the resin per hour to the resin. The adsorption step carried out by the column method is not particularly limited in terms of a direction of the flow of the perchlorate ion-containing liquid through the adsorption column, and the direction of the flow of the perchlorate ion-containing liquid may be downstream flow or upstream flow.

(I-2) Removing Step

The removing step in the present invention is a step of regaining adsorption ability of the weak base anion exchange resin by performing removal of the perchlorate ions adsorbed to the weak base anion exchange resin, by bringing an acid into contact with the weak base anion exchange resin to which the perchlorate ions are adsorbed.

In the method of the present invention for treating the perchlorate ion-containing liquid, the perchlorate ions from the weak base anion exchange resin to which the perchlorate ions are adsorbed can be appropriately removed by bringing an acid into contact with the weak base anion exchange resin to which the perchlorate ions are adsorbed.

The acid is not limited to particularly one, but may be preferably an inorganic acid, and may be more preferably sulfuric acid or hydrochloric acid.

The acid used in the removing step is not particularly limited as to its concentration, provided that the concentration makes it possible to remove the perchlorate ions from the weak base anion exchange resin to which the perchlorate ions are adsorbed. The concentration of the acid is preferably 5 wt % or more, more preferably 7 wt % or more, and further preferably 10 wt % or more. An upper limit of the concentration of the acid is more preferably 98 wt % or less.

When the concentration of the acid is 5 wt % or more, it is possible to appropriately remove the perchlorate ions from the weak base anion exchange resin to which the perchlorate ions are adsorbed, thereby regaining the adsorption ability of the weak base anion exchange resin.

Moreover, the concentration of the acid used in the removing step is preferably 1/n (mol/L) or more, more preferably 15/n (mol/L) or more, and further preferably 20/n (mol/L) ore more, where n is a valence of the acid. For example, when the acid is monovalent, the concentration of the acid used in the removing step is preferably 1 (mol/L) or more, more preferably 15 (mol/L) or more, and further preferably 20 (mol/L) or more. When the acid is divalent, the concentration of the acid used in the removing step is preferably 0.5 (mol/L) or more, more preferably 7.5 (mol/L) or more, and further preferably 10 (mol/L) or more. When the acid concentration is 1/n (mol/L) or more, it is possible to appropriately remove the perchlorate ions from the weak base anion exchange resin to which the perchlorate ions are adsorbed, thereby regaining the adsorption ability of the weak base anion exchange resin.

Moreover, the concentration used in the removing step may be kept constant or may be varied as appropriate. For example, in case where, after the adsorption step and the removing step are repeated over a long time, a quantity of the perchlorate ions adsorbed is reduced or a quantity (leak amount) of the perchlorate ions in the perchlorate ion-containing liquid having passed through the column is increased, the quantity of the perchlorate ions adsorbed by the weak base anion exchange resin can be regained, or the leak can be prevented by performing the removing step carried out with the acid of a higher concentration at least once. Here, the acid of a higher concentration may be, for example, an acid of 20 wt % or more, more preferably, and an acid of 25 wt % or more.

The removing step includes bringing an acid into contact with the weak base anion exchange resin to which the perchlorate ions are adsorbed by the adsorption step. Thereby, the removing step removes the perchlorate ions from the weak base anion exchange resin to which the perchlorate ions are adsorbed. How to bring the acid into contact with the weak base anion exchange resin to which the perchlorate ions are adsorbed is not particularly limited. For example, the weak base anion exchange resin to which the perchlorate ions are adsorbed may be immersed in the acid, thereby removing the perchlorate ions from the weak base anion exchange resin. The acid may be added to the weak base anion exchange resin to which the perchlorate ions, and then the weak base anion exchange resin is stirred or vibrated, so as to remove the perchlorate ions from the weak base anion exchange resin. As an alternative, a column method may be employed to bring an acid into contact with the weak base anion exchange resin to which the perchlorate ions are adsorbed. That is, the removal of the perchlorate ions from the weak base anion exchange resin may be performed by flowing the acid through a column in which the weak base anion exchange resin to which the perchlorate ions are adsorbed is charged.

Moreover, in the removing step, a temperature of the acid to be brought into contact with the weak base anion exchange resin to which the perchlorate ions are adsorbed is more preferably not lower than 20° C. but not higher than 80° C., and further preferably not lower than 35° C. but not higher than 80° C. By this, it is possible to efficiently remove the perchlorate ions from the weak base anion exchange resin to which the perchlorate ions are adsorbed.

The removing step carried out by the column method is not particularly limited as to a flow rate of the acid flowing through an adsorption column, and the flow rate may be optimized as appropriate, may be such that SV=5 to 20, more preferably.

The removing step carried out by the column method is not particularly limited in terms of a direction of the flow of the acid through the adsorption column, and the direction of the flow of the acid may be Co-Flow regeneration in which the acid is flowed in the same direction as the perchlorate ion-containing liquid in the adsorption step, or may be Counter-Flow regeneration in which the acid is flowed in an opposite direction to the perchlorate ion-containing liquid in the adsorption step. The Counter-Flow regeneration is more preferable, in terms of prevention of the leak of the perchlorate ions.

(II) Perchlorate Ion-Containing Liquid Treating Device

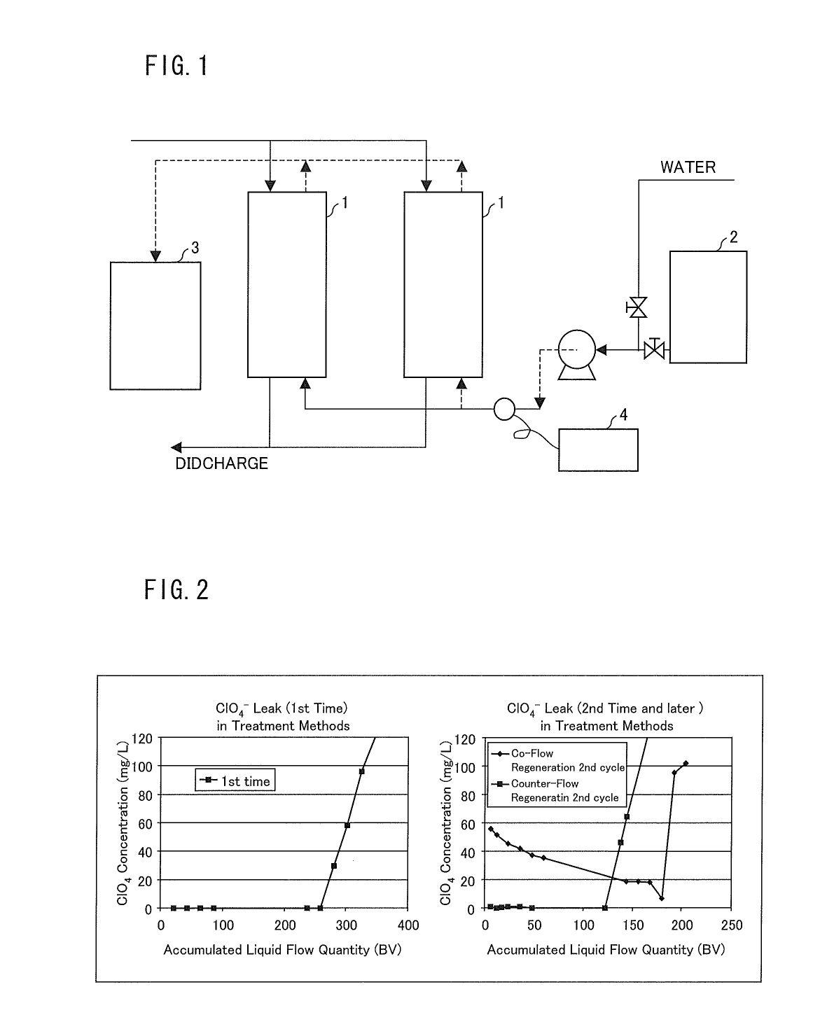

One embodiment of the perchlorate ion-containing liquid treating device usable in the present invention is described here, referring to FIG. 1. FIG. 1 is a schematic configuration view illustrating one example of the perchlorate ion-containing liquid treating device usable in the present invention.

As illustrated in FIG. 1, the perchlorate ion-containing liquid treating device includes an adsorption column 1 and a removing agent tank 2, and is configured such that an acid stored in the removing agent tank 2 can be supplied to the adsorption column 1 from the removing agent tank 2.

The adsorption column 1 is charged with the weak base anion exchange resin (not illustrated). The adsorption column 1 is connected with a pipe line via which a perchlorate ion-containing liquid to be treated is supplied from above the adsorption column 1, a pipe line via which the acid serving as a removing agent is supplied from the removing agent tank 2, a pipe line via which a post-treatment liquid is discharged after the perchlorate ion-containing liquid is flowed to cause the adsorption by the weak base anion exchange resin, and a pipe line via which the acid having been supplied from the removing agent tank 2 is discharged out of the adsorption column 1 after the acid is passed through the weak base anion exchange resin to which the perchlorate ions are adsorbed. The pipe line via which the acid having been supplied from the removing agent tank 2 is discharged after the acid is passed through the weak base anion exchange resin is connected to a waste tank 3.

The removing agent tank 2 stores the acid for removing the perchlorate ions from the weak base anion exchange resin to which the perchlorate ions are adsorbed, so as to regain the adsorption ability of the weak base anion exchange resin.

The adsorption column 1 is a device for carrying out (i) the adsorption step in which the perchlorate ion-containing liquid is brought into contact with the weak base anion exchange resin, so that the perchlorate ions are adsorbed to the weak base anion exchange resin, and (ii) the removing step in which the acid is brought into contact with the weak base anion exchange resin to which the perchlorate ions are adsorbed, so as to remove the perchlorate ions from the weak base anion exchange resin to which the perchlorate ions are adsorbed, and thereby to regain the adsorption ability of the weak base anion exchange resin. In the example illustrated in FIG. 1, the adsorption step is carried out by downstream flow and the removing step is carried out by upstream flow.

The acid stored in the removing agent tank 2 is supplied to the adsorption column 1 via the pipe line equipped with a pump. To this pipe line, a temperature adjusting device 4 is provided. The acid stored in the removing agent tank 2 is heated to a desired temperature by the temperature adjusting device 4, and then supplied to the adsorption column 1. Moreover, the pipe line equipped with the pump is connected with a pipe line for supplying water, so that the concentration of the acid can be adjusted.

In the example illustrated in FIG. 1, the perchlorate ion-containing liquid treating device is provided with two adsorption columns 1. By this, only one of the adsorption columns 1 which is not performing the removing step can be used if the other one of the adsorption columns 1 is performing the removing step. In this way, the perchlorate ion-containing liquid treatment can be performed continuously.

The perchlorate ion-containing liquid treating device usable in the present invention is not limited to the example illustrated in FIG. 1, in which two adsorption columns 1 are provided. The perchlorate ion-containing liquid treating device usable in the present invention may be provided with only one adsorption column 1. Moreover, the perchlorate ion-containing liquid treating device usable in the present invention is not limited to the configuration in which the perchlorate ion-containing liquid is supplied from above the adsorption column 1, and may be configured such that the perchlorate ion-containing liquid is supplied from below the adsorption column 1. Further, the removing step may be carried out by Co-Flow regeneration. Further, the temperature adjusting device 4 is not essential and the acid not heated may be supplied to the adsorption column 1. In view of efficiency in the removing step, a temperature adjusting device may be provided for heating the acid to be supplied to the adsorption column.

That is, the present application encompass the following inventions.

In order to attain the object, a method according to the present invention for treating a perchlorate ion-containing liquid, includes: an adsorption step for bringing the perchlorate ion-containing liquid into contact with a weak base anion exchange resin, so that perchlorate ions are adsorbed to the weak base anion exchange resin; and a removing step for bringing an acid into contact with the weak base anion exchange resin to which the perchlorate ions are adsorbed, so as to remove the perchlorate ions from the weak base anion exchange resin.

With this arrangement, it is possible to regain the adsorption ability of the weak base anion exchange resin by removing the perchlorate ions from the weak base anion exchange resin to which the perchlorate ions are adsorbed. Therefore, the weak base anion exchange resin can be repeatedly used.

It is preferable in the method according to the present invention that the weak base anion exchange resin is such that a ratio of a neutral salt splitting capacity to a total exchange capacity is not less than 0 but not more than 40%.

With this arrangement in which the weak base anion exchange resin is such that a ratio of a neutral salt splitting capacity to a total exchange capacity is not less than 0 but not more than 40%, it is possible to more appropriately remove the perchlorate ions from the weak base anion exchange resin to which the perchlorate ions are adsorbed. Therefore, the weak base anion exchange resin can be repeatedly used.

It is preferable in the method according to the present invention that the acid is sulfuric acid or hydrochloric acid.

It is preferable in the method according to the present invention that the acid has such a concentration of 1/n mol/L or more, where n is a valence of the acid.

With this arrangement in which the acid has such a concentration of 1/n mol/L or more, where n is a valence of the acid, it becomes possible to regain the adsorption ability of the weak base anion exchange resin by appropriately removing the perchlorate ions from the weak base anion exchange resin to which the perchlorate ions are adsorbed.

It is preferable in the method according to the present invention that, before being treated, the perchlorate ion-containing liquid has a perchlorate ion concentration of not less than 10 μg/L but not more than 1000 mg/L.

With this arrangement, it becomes possible to attain perchlorate ion concentration reduction for perchlorate ion-containing liquids of a wide range of perchlorate ion concentration. Therefore, the method of the present invention is not only applicable to appropriately treat industrial waste water etc. containing a large amount of perchlorate ions, but also applicable to water treatment in water purification plants for drinking water such as tap water.

It is preferable in the method according to the present invention that in the removing step the acid heated to a temperature of not lower than 20° C. but not higher than 80° C. is brought into contact with the weak base anion exchange resin.

With this arrangement, it becomes possible to more efficiently remove the perchlorate ions from the weak base anion exchange resin to which the perchlorate ions are adsorbed.

It is preferable in the method according to the present invention that the weak base anion exchange resin is repeatedly used in such a manner that the perchlorate ions are removed from the weak base anion exchange resin by bringing the acid in contact with the weak base anion exchange resin to which the perchlorate ions are adsorbed, and then the weak base anion exchange resin is used again to adsorb the perchlorate ions thereto.

A method according to the present invention is a method for removing perchlorate ions, comprising: bringing an acid into contact with a weak base anion exchange resin to which perchlorate ions are adsorbed, so as to remove the perchlorate ions from the weak base anion exchange resin, in order to regain an adsorption ability of the weak base anion exchange resin.

With this arrangement, it is possible to regain the adsorption ability of the weak base anion exchange resin by removing the perchlorate ions from the weak base anion exchange resin to which the perchlorate ions are adsorbed. Therefore, the weak base anion exchange resin can be repeatedly used.

### EXAMPLES

In the following, the present invention is described in more detail, referring to Examples and Comparative Example, which are not to limit the present invention.

In the Examples and Comparative Examples, salt splitting capacities and the total exchange capacities of base anion exchange reins used therein were measured by methods described below.

(i) Measurement of Neutral Salt Splitting Capacity and Total Exchange Capacity of Strong Base Anion Exchange Resin

A neutral salt splitting capacity and a total exchange capacity of duolite A113LF and duolite A116LF, which are strong base anion exchange resin used in the later described Comparative Examples, were determined in the following methods.

<Measurement of Neutral Salt Splitting Capacity>

About 60 ml of a base anion exchange resin was charged in a column. 2 mol/L NaOH 1 L was flowed through the column in such a manner that SV=8 (2 hours). Then, ion exchanged water 1 L was flowed through the column in such a manner that SV=8 (2 hours). After that, the column was washed with water until discharged water discharged from the column became approximately neutral (pH=<8).

5% NaCl 1.5 L was flowed through the column in such a manner that SV=16 (1.5 hours), while receiving, with a beaker, whole discharged water discharged from the column. To the discharged water thus collected, ion exchanged water was added to make up a volume of 2.0 L.

Ion exchanged water 0.4 L was flowed through the column in such a manner that SV=16 (0.33 hours). After that, the base anion exchange resin was removed from the column. The base anion exchange resin thus removed and water were put into a measuring cylinder and vibrated for 1 minute by using a vibrator. Then, the base anion exchange resin was measured in volume, so as to determine a minimum volume V.

From the discharged water adjusted to the volume of 2.0 L, 100 ml was sampled and was subjected to neutralization titration with 1 mol/L HCl. Then, neutral salt splitting capacity thereof was calculated out from Equation (1).

Neutral Salt Splitting Capacity (unit: eq/L-R)=(N1×(V1×2000/100))/V (1)

where N1=concentration of HCl (unit: mol/L), and V1=titer (unit: ml). R indicates a Cl form wet resin.

<Measurement of Total Exchange Capacity>

Next, the base anion exchange resin after the measurement of the neutral salt splitting capacity was charged in a column. 0.1 mol/L HCl 400 ml was flowed through the column in such a manner that SV=12 (0.5 hours), while receiving, with a beaker, whole discharged water discharged from the column. The concentration (0.1 mol/L) and the volume of HCl used here are referred to as N2 and V2, respectively.

Ion exchanged water 0.1 L was flowed in such a manner that SV=16 (0.1 hours), while receiving, with the beaker, whole discharged water discharged from the column. To the discharged water thus collected, ion exchanged water was added to make up a volume of 0.6 L. The base anion exchange resin was removed from the column. Then, the base anion exchange resin thus removed and water were put into a measuring cylinder and then the base anion exchange resin was measured in volume, so as to determine a minimum volume V0.

From the discharge water adjusted to a total volume of 0.6 L, 100 ml was sampled and subjected to neutralization titration with 1 mol/L NaOH. Then, a weak base capacity was calculated from Equation (2).

Weak Base Capacity (unit: eq/L-R)=(N2−V2−(N3×V3×600/100))/V0 (2)

where N3=Concentration of NaOH (unit: 1 mol/L), and V3=titer (unit: ml).

Further, from Equation (3), a total exchange capacity was calculated.

Total Exchange Capacity=Neutral Salt Splitting Capacity+Weak Base Capacity (3)

The neutralization titration was carried out with an end point of pH=7.0 with COMTIT 500, which was commercially available from Hiranuma, and equipped with electrodes GE-101 and RE-201.

(ii) Measurement of Neutral Salt Splitting Capacity and Total Exchange Capacity of Weak Base Anion Exchange Resin

Neutral salt splitting capacity and total exchange capacity of sumichelate MC 300 and purolite A870, which are weak base anion exchange resin used in Examples below were determined by the following methods.

<Measurement of Neutral Salt Splitting Capacity>

Measurement of neutral salt splitting capacity was carried out in the same way as in (i) above.

<Measurement of Total Exchange Capacity>

About 60 ml of the weak base anion exchange resin was sampled and charged into a column. 2 mol/L NaOH 0.2 L was flowed through the column in such a manner that SV=7 (0.5 hours), and then ion exchanged water 0.6 L was flowed through the column in such a manner that SV=15 (0.7 hours). Then, the column was washed with waster until discharged water reached pH of 8 to 9.

The weak base anion exchange resin was removed from the column. The weak base anion exchange resin thus removed and water were put into a measuring cylinder and vibrated for 1 minute by using a vibrator. Then, the base anion exchange resin was measured in volume, so as to determine a minimum volume V.

0.1 mol/L HCL 1.5 L was flowed through the column in such a manner that SV=12 (2 hours), while receiving, with a beaker, whole discharged water discharged from the column. The concentration (0.1 mol/L) and the volume of HCl used here are referred to as N1 and V1, respectively.

Ethanol 0.1 L was flowed through the column in such a manner that SV=6 (0.2 hours), while receiving, with the beaker used above, whole discharged water discharged from the column. Ion exchanged water was added to the sum of the discharged water to make up a total volume of 2.0 L.

100 ml was sampled from the discharged water adjusted to the total volume of 2.0 L, and subjected to neutralization titration with NaOH of 1 mol/L. Then, a total exchange capacity was calculated from Equation (4).

Total Exchange Capacity (eq/L-R)=(N1×V1−(N2×V2×2000/100))/V (4)

where N1=concentration of NaOH (unit: 1 mol/L), and V2=titer (unit: ml).

The neutralization titration was carried out with an end point of pH=7.0 with COMTIT 500, which was commercially available from Hiranuma, and equipped with electrodes GE-101 and RE-201.

### Example 1

### Analysis of Perchlorate Ion Concentration Reduction in Pre-Treatment Liquid by Adsorption Test after Removing Process with 1 Equivalent Amount of Sulfuric Acid

A batch adsorption/removal test for perchlorate ion-containing liquid was carried out with sumichelate MC 300, which is a styrene type weak base anion exchange resin (commercially available from Sumika Chemtex Co., Ltd.). The sumichelate MC 300 had a total exchange capacity of 1.4 eq/L-R, a neutral salt splitting capacity of 0.09 eq/L-R, and a ratio of the neutral salt splitting capacity to the total exchange capacity was 6.4%.

Firstly, sumichelate MC 300 was converted with 10 wt % H₂SO₄ to a SO₄ form. 0.2 mL of the resin converted to the SO₄ form, and 50 mL of a perchlorate ion-containing liquid (perchlorate ion concentration: 424 mg/L, pH: 9.2) were introduced in a 100 mL vessel and shaken at room temperatures (20° C. to 25° C.) for 20 hours, so that the perchlorate ions were adsorbed to the resin.

The resin was removed from the 100 mL vessel, and washed with 10 mL of ion exchanged water. Next, into a 50 mL vessel, the water-washed resin and 20 mL of a H₂SO₄ aqueous solution of 0.5 mol/L were introduced, and shaken at room temperatures (20° C. to 25° C.) for 20 hours. Then, the resin was removed from the 50 mL vessel, and washed with 100 mL of ion exchanged water.

The water-washed resin was introduced in a 100 mL vessel, and 50 mL of a perchlorate ion-containing liquid (perchlorate ion concentration: 424 mg/L, pH: 9.2) were added. Then, the mixture was shaken at room temperatures (20° C. to 25° C.) for 20 hours, so that the perchlorate ions were adsorbed to the resin. Then, a supernatant liquid thereof in the vessel was measured in perchlorate ion concentration, so as to obtain a perchlorate ion concentration reduction rate from the pre-treatment solution. The perchlorate ion concentration reduction rate from the pre-treatment solution was 21%. From these results, it was found that the perchlorate ions adsorbed to the weak base anion exchange resin were removed from the weak base anion exchange resin when sulfuric acid was brought into contact with the weak base anion exchange resin to which the perchlorate ions were adsorbed. Table 1 shows evaluation on the acid-contact removal of the perchlorate ions from the weak base anion exchange resin to which the perchlorate ions were adsorbed. In Table 1, “good” indicates that the perchlorate ions were removed by the acid contact from the weak base anion exchange resin to which the perchlorate ions were adsorbed, while “excellent” indicates that the perchlorate ions were excellently removed by the acid contact from the weak base anion exchange resin to which the perchlorate ions were adsorbed.

TABLE 1

Removing Agent

| | H₂SO₄ | H₂SO₄ | HCl |
|---|---|---|---|
| | 0.5 mol/L | 1 mol/L | 4 mol/L |
| Evaluation on | Good | Excellent | Excellent |
| the acid-contact | | | |
| removal of the | | | |
| perchlorate ions | | | |
| from the weak | | | |
| base anion | | | |
| exchange resin to | | | |
| which the | | | |
| perchlorate ions | | | |
| were adsorbed | | | |

### Example 2

### Analysis of Perchlorate Ion Concentration Reduction in Pre-Treatment Liquid by Adsorption Test after Removing Process with 2 Equivalent Amount of Sulfuric Acid

A batch adsorption/removal test for a perchlorate ion-containing liquid was performed in the same way as in Example 1, except that 1 mol/L of a H₂SO₄ aqueous solution was used as the removal agent.

The perchlorate ion concentration reduction from the pre-treatment solution was 43%. This was evaluated as “excellent” as shown in table 1.

### Example 3

### Analysis of Perchlorate Ion Concentration Reduction in Pre-Treatment Liquid by Adsorption Test after Removing Process with 4 Equivalent Amount of Hydrochloric Acid

A batch adsorption/removal test for a perchlorate ion-containing liquid was performed in the same way as in Example 1, except that 4 mol/L of a HCL solution was used as the removal agent.

The perchlorate ion concentration reduction from the pre-treatment solution was 52%. This was evaluated as “excellent” as shown in table 1.

### Example 4

### Test on Column Recyclability in Repeating Liquid Flow Adsorption and Removal for Perchlorate Ion-Containing Liquid

A liquid flow adsorption/removal test for a perchlorate ion-containing liquid was repeated with sumichelate MC 300 (commercially available from Sumika Chemtex Co., Ltd.).

In a column (internal diameter: 6 mm, height 500 mm) with an outer tube, 10 mL of MC 300 (free type) was charged.

<Liquid Flow Adsorption and Removal Test for 1 Cycle>

A perchlorate ion-containing liquid (perchlorate ion concentration: 180 mg/L, pH: 8.1) was flowed through the column at room temperatures (20° C. to 25° C.) by a downstream flow in such a manner that SV=5. This was continued until the perchlorate ions break through (adsorption step). From a total loading amount of the perchlorate ions in the perchlorate ion-containing liquid thus flowed through the column, and an amount (leak amount) of the perchlorate ions in the perchlorate ion-containing liquid flowed out from the column, an adsorption amount of the perchlorate ions adsorbed to the resin was calculated out.

Through the column after the adsorption of the perchlorate ions, 10 BV of 20 wt % of H₂SO₄ at 50° C. was flowed by an upstream flow in such a manner that SV=2 (removing step). Here, “BV” is a ratio of the flow rate of flowed pre-treatment liquid to the volume of resin through which the pre-treatment liquid was flowed.

After that, through the column through which 20 wt % of H₂SO₄ has been flowed, 10 BV of ion exchanged water was flowed at room temperatures (20° C. to 25° C.) by a downstream flow in such a manner that SV=10.

<Repeating of Liquid Flow Adsorption/Removal Test>

By using the water-washed resin, the liquid flow adsorption/removal test was repeated until 5th cycle in the same manner as in the first cycle. Moreover, as a retention ratio of the adsorption amount, a ratio of the adsorption amount of the perchlorate ions to the resin at the first cycle and adsorption amounts of the same at the other cycles was calculated out. The results are shown in Table 2. The adsorption amounts at the third and fifth cycle are equivalent. Thus, it is predicted that the adsorption amounts will be maintained even up to ten cycles.

TABLE 2

| | | MC300 | A870 | A113LF | A116LF |
|---|---|---|---|---|---|
| 1st | total loaded | 648.0 | 849.6 | 864.0 | 864.0 |
| cycle | amount (mg) | | | | |
| | leak amount | 220.6 | 229.7 | 15.3 | 101.3 |
| | (mg) | | | | |
| | adsorption | 427.4 | 619.9 | 848.7 | 762.7 |
| | amount (mg) | | | | |
| | retention ratio | 100.0 | 100.0 | 100.0 | 100.0 |
| | (%) | | | | |
| 2nd | total loaded | 648.0 | 849.6 | 864.0 | 864.0 |
| cycle | amount (mg) | | | | |
| | leak amount | 237.5 | 335.5 | 25.7 | 176.1 |
| | (mg) | | | | |
| | adsorption | 410.5 | 514.1 | 838.3 | 687.9 |
| | amount (mg) | | | | |
| | retention ratio | 96.0 | 82.9 | 98.8 | 90.2 |
| | (%) | | | | |
| 3rd | total loaded | 648.0 | 849.6 | 864.0 | 864.0 |
| cycle | amount (mg) | | | | |
| | leak amount | 335.5 | 647.3 | 275.8 | 593.8 |
| | (mg) | | | | |
| | adsorption | 312.5 | 202.3 | 588.2 | 270.2 |
| | amount (mg) | | | | |
| | retention ratio | 73.1 | 32.6 | 69.3 | 35.4 |
| | (%) | | | | |
| 4th | total loaded | | 849.6 | | |
| cycle | amount (mg) | | | | |
| | leak amount | | 807.1 | | |
| | (mg) | | | | |
| | adsorption | | 42.5 | | |
| | amount (mg) | | | | |
| | retention ratio | | 6.9 | | |
| | (%) | | | | |
| 5th | total loaded | 604.8 | 849.6 | 806.4 | 806.4 |
| cycle | amount (mg) | | | | |
| | leak amount | 291.6 | 807.8 | 614.4 | 705.6 |
| | (mg) | | | | |
| | adsorption | 313.2 | 41.8 | 192.0 | 100.8 |
| | amount (mg) | | | | |
| | retention ratio | 73.3 | 6.7 | 22.6 | 13.2 |
| | (%) | | | | |
| 10th | retention ratio | About | Retained | Not | Not |
| cycle | (%) | 70% | | retained | retained |

### Example 5

### Test on Column Recyclability in Repeating Liquid Flow Adsorption and Removal for Perchlorate Ion-Containing Liquid

A liquid flow adsorption/removal test for a perchlorate ion-containing liquid was carried out in the same manner as in Example 4, except that purolite A870 of Purolite international K.K. was used as the weak base anion exchange resin, and the perchlorate ion concentration in the perchlorate ion-containing liquid was 118 mg/L. Purolite A870 has a total exchange capacity of 1.2 eq/L, and a neutral salt splitting capacity of 0.44 eq/L, and a ratio of the neutral salt splitting capacity to the total exchange capacity was 36.7%. The results are shown in Table 2. The adsorption amounts in the 4th and 5th cycles are equivalent to each other. It is predicted that the adsorption amount will be retained even up to 10 cycles.

### Example 6

Lewatit MP62 of Lanxess, which is a weak base anion exchange resin, had a total exchange capacity of 1.6 eq/L-R, a neutral salt splitting capacity of 0.05 eq/L-R, and a ratio of the neutral salt splitting capacity to the total exchange capacity was 3.1%. A batch adsorption test for the perchlorate ion-containing liquid was carried out with the resin, thereby finding that a removing rate was 25%. The batch adsorption test was carried out by adding the lewatit MP 62 of an OH form to 50 ml of the perchlorate ion-containing liquid of perchlorate ion concentration of 174 mg/L, and shaken it at room temperature for 20 hours. The ratio of the neutral salt splitting capacity to the total exchange capacity was 3.1%, and the removing ratio was 25%. Thus, it is predicted that the adsorption amount will be maintained even after the same process as in Example 4 is repeated for 10 cycles.

### Example 7

Lewatit MP64 of Lanxess, which is a weak base anion exchange resin, had a total exchange capacity of 1.3 eq/L-R, a neutral salt splitting capacity of 0.18 eq/L-R, and a ratio of the neutral salt splitting capacity to the total exchange capacity was 13.8%. A batch adsorption test for the perchlorate ion-containing liquid was carried out with the resin in the same manner as in Example 6, thereby finding that a removing rate was 29%. The ratio of the neutral salt splitting capacity to the total exchange capacity was 13.8%, and the removing ratio was 29%. Thus, it is predicted that the adsorption amount will be maintained even after the same process as in Example 4 is repeated for 10 cycles.

### Comparative Example 1

### Test on Column Recyclability in Repeating Liquid Flow Adsorption and Removal for Perchlorate Ion-Containing Liquid

A liquid flow adsorption/removal test for a perchlorate ion-containing liquid was carried out in the same manner as in Example 4, except that duolite (registered trademark) A113LF (commercially available from Sumika Chemtex Co., Ltd.), which is a strong base anion exchange resin, was used as the base anion exchange resin. Duolite A113LF had a total exchange capacity of 1.2 eq/L-R, a neutral salt splitting capacity of 1.2 eq/L-R, and a ratio of the neutral salt splitting capacity to the total exchange capacity was 100.0%. The results are shown in table 2.

### Comparative Example 2

### Test on Column Recyclability in Repeating Liquid Flow Adsorption and Removal for Perchlorate Ion-Containing Liquid

A liquid flow adsorption/removal test for a perchlorate ion-containing liquid was carried out in the same manner as in Example 4, except that duolite (registered trademark) A116LF (commercially available from Sumika Chemtex Co., Ltd.), which is a strong base anion exchange resin, was used as the base anion exchange resin. Duolite A116LF had a total exchange capacity of 1.3 eq/L-R, a neutral salt splitting capacity of 1.3 eq/L-R, and a ratio of the neutral salt splitting capacity to the total exchange capacity was 100.0%. The results are shown in table 2.

In Table 2, the “retention ratio” is a retention ratio that is calculated by the above method and indicates a ratio of an adsorption amount of the other cycles to an adsorption amount of the first cycle. Table 2 shows that the adsorption amounts in duolite A113LF and A116LF were dramatically reduced continuously through the repeated usage from the first cycle to the fifth cycle. Compared with them, the adsorption amount in sumichelate MC300 was hardly reduced after the third cycle and the retention ratio of the adsorption amount was over 70% even in the fifth cycle. These results explain that sumichelate MC300 maintains its adsorption amount significantly well, compared with duolite A113LF and A116LF. Moreover, the results shows that the reduction in the adsorption amount was stopped in the fourth cycle in purolite A870.

Further, a larger-scale liquid flow adsorption/removal test using sumichelate MC300 was conducted by performing the removing step once a day. The larger-scale liquid flow adsorption/removal test confirmed that the adsorption amount of the perchlorate ions was not changed much even after 5 months.

### Example 8

### Confirmation of Perchlorate Removal of the Perchlorate Ion-Containing Liquid by Full-Scale Test

A liquid flow adsorption/removal test of a perchlorate ion-containing liquid was repeatedly carried out by mounting 1500 L of Sumichelate MC300 (commercially available from Sumika chemtex Co., Ltd.) in actual equipment and adopting a Counter-Flow regeneration mode. The removing step was carried out once a day. The perchlorate ion-containing liquid had a perchlorate ion concentration of 100 mg/L to 250 mg/L, and pH of 8.5 to 9.5.

While inspecting the concentration (hereinafter, outlet concentration) of the perchlorate ions in the perchlorate ion-containing liquid passed through the column, the adsorption/removal test was repeated by the constant volume treatment. The removal was carried out at 50° C. with 23 wt % H₂SO₄ as a removing agent. The outlet concentration of the perchlorate ions was kept in a stationary state of less than 0.1 mg/L constantly for 5 months, but was increased to 2 mg/L after 6 months.

In response to this change, the regeneration condition was altered such that the removal was carried out at 55° C. with 29 wt % H₂SO₄ only once. This returned the outlet concentration of the perchlorate ions in the adsorption step to the stationary state of less than 0.1 mg/L.

### Example 9

### Perchlorate Ion Removing Test for Low-Concentrated Perchlorate Ion-Containing Liquid

Removal of perchlorate ions from a low-concentrated perchlorate ion-containing liquid was examined with sumichelate MC300.

To begin with, 80 mL of sumichelate MC300 (free type) was charged in a column (internal diameter: 9 mm, height 1500 mm) with an outer tube.

10 BV of H₂SO₄ (2.5 mol/L) was flowed through the column at 50° C. After the liquid flowing, 2 BV of ion exchanged water was flowed through the column at room temperatures (20° C. to 25° C.) by a downstream flow in such a manner that SV=2. Further, 10 BV of ion exchanged water was flowed through the column at room temperatures (20° C. to 25° C.) by a downstream flow in such a manner that SV=10.

A pre-treatment liquid was prepared by adding sodium perchlorate in tap water in Osaka city to make up a perchlorate ion concentration of 110 μg/L and pH of 7.78. The pre-treatment liquid was then flowed through the water-washed column at room temperatures (20° C. to 25° C.) by a downstream flow in such a manner that SV=2. A liquid passed through the column was sampled to measure perchlorate ion concentration therein.

The results are shown in Table 3. As shown in Table 3, the perchlorate ion concentration in the liquid passed through the column could be removed 10 μg/L at most. As demonstrated here, the treatment method according to the present invention can appropriately remove perchlorate ions even from such a low-concentrated perchlorate ion-containing liquid that the perchlorate ion concentration is about 100 μg/L.

TABLE 3

| Liquid-to-Resin Ratio BV | ClO₄ leak (μg/L) |
|---|---|
| 1 | — |
| 2 | — |
| 3 | — |
| 5 | — |
| 9 | — |
| 17.5 | <10 |
| 25 | 10 |
| 40 | <10 |
| 55 | <10 |
| 70 | <10 |

### Example 10

### Liquid Flow Adsorption/Removal Test of Perchlorate Ion-Containing Liquid

How to flow the liquid in the removing step was investigated in the liquid flow adsorption/removal test for the perchlorate ion-containing liquid with sumichelate MC300.

To being with, 1.8 L of sumichelate MC300 (free type) was charged in columns (internal diameter 6.5 cm, height 70 cm).

<Liquid Flow Adsorption/Removal Test of First Cycle>

A perchlorate ion-containing liquid (perchlorate ion concentration: 113 mg/L pH: about 9) was flowed though the columns at room temperatures (20° C. to 25° C.) by a downstream flow in such a manner that SV=6. This was continued until the perchlorate ions break through (adsorption step). Liquids passed through the columns were sampled at predetermined timings for perchlorate ion concentration analysis. The results are shown in the graph on the left-hand side in FIG. 2.

Through the columns after the adsorption of the perchlorate ions, 10 BV of H₂SO₄ of about 29 wt % was flowed at 70° C. by two different ways, namely, by an upstream flow and a downstream flow, in such a manner that SV=2 (removing step). Next, through the columns after the passing of H₂SO₄ of about 29 wt % therethrough, 2 BV of ion exchanged water was flowed at room temperatures (20° C. to 25° C.) by the downstream flow in such a manner that SV=2.

<Liquid Flow Test at Second Cycle>

After performing the removing step by passing the liquid in the two different ways, the perchlorate ion-containing liquid was passed through the columns in the same way as in the liquid flow adsorption/removal test in the first cycle. Liquids passed through the columns were sampled at predetermined timings for perchlorate ion concentration analysis. The results are shown in the graph on the right-hand side in FIG. 2. As shown in the right-hand side graph in FIG. 2, the removal with the upstream flow is preferable to the removal with the downstream flow, because the removal with the upstream flow showed a lower perchlorate ion concentration, compared to the removal with the downstream flow.

### INDUSTRIAL APPLICABILITY

According to the treatment method of the present invention for treating a perchlorate ion-containing liquid, perchlorate ions can be appropriately removed from a weak base anion exchange resin to which the perchlorate ions are adsorbed, whereby the weak base anion exchange resin can regain its adsorption ability. Because of this, the weak base anion exchange resin can be repeatedly used, thereby making it possible to efficiently treat perchlorate ions in ground water, soil, hot spring water, pond or lake water, sea water, industrial waste water, mine waste water, river water, etc. Therefore, the present invention is applicable to chemical industries, which discharge perchlorate ion-containing liquid, and waterworks, etc. As such, the present invention is a very useful invention.

### REFERENCE SIGNS LIST

1: Adsorption Column
2: Removing Agent Tank
3: Waste Tank
4: Temperature Adjusting Device

1. A method for treating a perchlorate ion-containing liquid, comprising:
an adsorption step for bringing the perchlorate ion-containing liquid into contact with a weak base anion exchange resin, so that perchlorate ions are adsorbed to the weak base anion exchange resin; and
a removing step for bringing an acid into contact with the weak base anion exchange resin to which the perchlorate ions are adsorbed, so as to remove the perchlorate ions from the weak base anion exchange resin.

2. The method as set forth in claim 1, wherein the weak base anion exchange resin is such that a ratio of a neutral salt splitting capacity to a total exchange capacity is not less than 0 but not more than 40%.

3. The method as set forth in claim 1, wherein the acid is sulfuric acid or hydrochloric acid.

4. The method as set forth in claim 1, wherein the acid has such a concentration of 1/n mol/L or more, where n is a valence of the acid.

5. The method as set forth in claim 1, wherein, before being treated, the perchlorate ion-containing liquid has a perchlorate ion concentration of not less than 10 μg/L but not more than 1000 mg/L.

6. The method as set fort in claim 1, wherein in the removing step the acid heated to a temperature of not lower than 20° C. but not higher than 80° C. is brought into contact with the weak base anion exchange resin.

7. The method as set forth in claim 1, wherein the weak base anion exchange resin is repeatedly used in such a manner that the perchlorate ions are removed from the weak base anion exchange resin by bringing the acid in contact with the weak base anion exchange resin to which the perchlorate ions are adsorbed, and then the weak base anion exchange resin is used again to adsorb the perchlorate ions thereto.

8. A method for removing perchlorate ions, comprising:
bringing an acid into contact with a weak base anion exchange resin to which perchlorate ions are adsorbed, so as to remove the perchlorate ions from the weak base anion exchange resin, in order to regain an adsorption ability of the weak base anion exchange resin.
